(19) United States
(12) Patent Application Publication
(10) Pub. No.: US 2010/0102909 A1
(43) Pub. Date: Apr. 29, 2010

(54) SOLENOID PLUNGER HOUSING MADE OF METALS OF DIFFERENT MAGNETIC PERMEABILITY

(76) Inventor: Thomas Feucht, Wimsheim (DE)

Correspondence Address: KENYON & KENYON LLP, ONE BROADWAY, NEW YORK, NY, 10004, US

(21) Appl. No.: 12/451,601

(22) PCT Filed: Jun. 6, 2008
(86) PCT No.: PCT/EP2008/004526

§ 371 Date: Nov. 19, 2009

(30) Foreign Application Priority Data
Jun. 13, 2007 (DE) 10 2007 027 149.4

(51) Int. Cl. H01F 7/08

(52) U.S. Cl. 335/261

(57) ABSTRACT

A solenoid plunger housing including at least one electric coil equipped with windings, as well as at least one solenoid plunger cooperating with it, which, as a function of its plunging depth into a coil opening of the coil, brings about a different inductance of the coil. The solenoid plunger, in a radially outer section, is made at least partially of an electrically conductive nonferrous metal, and in a radially inner section, is made at least partially of a ferromagnetic material.

### FIELD OF THE INVENTION

The present invention relates to a solenoid plunger housing including at least one electrical coil provided with windings and at least one solenoid plunger cooperating with it which, as a function of its plunging depth into a coil opening of the coil, brings about a different inductance of the coil.

### BACKGROUND INFORMATION

Known solenoid plunger housings are used in electronic pedal modules of motor vehicles, and they are used to measure the motion of a pedal, especially a brake pedal or a gas pedal. Depending on the plunging depth of the solenoid plunger into the coil opening or the overlapping ratio between the coil and the solenoid plunger, the magnetic resistance of the magnetic circuit changes, and with that, the self-inductance of the coil. The linear behavior of the solenoid plunger housing is then achieved by the essentially linear dependence of the overlapping ratio which comes about between the solenoid plunger and the coil.

The solenoid plunger is mostly made of aluminum. This has advantages compared to a solenoid plunger made of a ferromagnetic material with respect to weight, because of which the dynamic behavior during an external excitation of vibrations is also better. In addition, aluminum is easily workable and resistant to corrosion.

For the various applications, such as in a pedal module in a commercial vehicle, solenoid plunger housings may be used that are light, compact and have a high measuring sensitivity. The present invention is therefore based on the object of creating a solenoid plunger housing having all these properties.

According to the present invention, this object is attained by the features described herein.

### SUMMARY OF THE INVENTION

The present invention is based on the idea that, according to a first alternative, the solenoid plunger is made partially of an electrically conductive nonferrous metal in a radially outer section and partially of a ferromagnetic material in a radially inner section.

According to a second alternative, a ring is situated directly or indirectly at a radially inner circumferential surface that is made at least partially of an electrically conductive nonferrous metal, and the solenoid plunger is made at least partially of a ferromagnetic material.

Accordingly, the outer section of the solenoid plunger, made of the electrically conductive nonferrous metal, or the outer ring assigned to the coil, screens the inner section of the solenoid plunger or the solenoid plunger from the magnetic lines of force of the magnetic field of the coil. Now, if the outer section of the solenoid plunger, that is made of the electrically conductive nonferrous metal, or the ring is introduced into an alternating magnetic field, eddy currents are created in the section or the ring, which generate a magnetic field in the opposite direction to the magnetic field generated by the coil, and which thereby weaken the magnetic field of the coil. Now, inasmuch as the radially inner section of the solenoid plunger or the solenoid plunger is at least partially made of a ferromagnetic material, according to the present invention, the reverse magnetic field, generated by the eddy currents in the outer section of the solenoid plunger or in the ring, is intensified. Because of this reverse magnetic field that was then intensified by the radially inner ferromagnetic material, the magnetic field of the coil is more greatly weakened than in the related art, which uses a solenoid plunger made exclusively of aluminum (a nonferrous metal). This effect has the result that the solenoid plunger housing, according to the present invention, advantageously reacts more sensitively with respect to relative motions between the solenoid plunger and the coil. This greater sensitivity permits a shorter size of the solenoid plunger housing, because even slight relative motions between the coil and the solenoid plunger supply a high signal resolution.

Since only a part of the solenoid plunger housing is made of a heavier, ferromagnetic material, but the other part is still made of a lighter, nonferrous metal, such as aluminum, the solenoid plunger housing still ends up being relatively light.

The measures set forth in the dependent claims allow for advantageous further developments and improvements of the invention specified in the independent claims.

It particularly may be provided that if the nonferrous metal is paramagnetic or diamagnetic, at a high electrical conductivity at the same time, in order to generate eddy currents that are as strong as possible, and with that, as large as possible a reverse magnetic field, which acts counter to the magnetic field of the coil. The nonferrous metal may be formed by aluminum or by an aluminum alloy.

According to one refinement of the first alternative of the present invention, the radially inner section of the solenoid plunger, made at least partially of a ferromagnetic material, forms a one-piece core of the solenoid plunger. This core may be embedded at least partially in the radially outer section of the solenoid plunger, which is made up of the electrically conductive nonferrous metal. Furthermore, the core may extend only over a part of the length of the solenoid plunger. This may, for instance, be implemented in that the radially outer section of the solenoid plunger has a central blind-end bore, into which the core is inserted. The core is able to terminate flush with an end face of the solenoid plunger, in this context.

According to one refinement of the second alternative of the present invention, the ring made up of the electrically conductive nonferrous metal forms at least one part of the coil shell of the coil, for instance, in that the ring is at least partially embedded in the coil shell. This may be implemented in that the coil shell is an injection molded blank made of plastic into which the ring is cast, for example.

Alternatively, the ring made of the electrically conductive nonferrous metal may not be integrated into the coil shell of the coil or connected directly to the coil shell, but be situated only at its radially inner circumferential surface.

In exemplary embodiment, the solenoid plunger is made completely of the ferromagnetic material. An improved magnetic shielding, of the solenoid plunger from the magnetic field of the coil, comes about if the ring laterally projects beyond the coil winding by a portion. The ring gap arranged between the solenoid plunger and the ring, as seen in the radial direction, which may contain air.

Further details emerge from the following description of exemplary embodiments.

Below, exemplary embodiments of the present invention are represented in the drawings and are explained in detail in the subsequent description.

### BRIEF DESCRIPTION OF THE DRAWINGS

FIG. 1 shows a schematic cross sectional view of a solenoid plunger housing according to a first specific embodiment of the present invention.

FIG. 2 shows a schematic cross sectional view of a solenoid plunger housing according to an additional specific embodiment of the present invention.

### DETAILED DESCRIPTION

One application of a solenoid plunger housing 1 according to the present invention is, for instance, to measure the pedal path of an electronic brake pedal or gas pedal, for example, in an electronic pedal module of a vehicle. For this purpose, a coil 2 of solenoid plunger housing 1 is connected to the bearing block, for example, and a solenoid plunger 4 of solenoid plunger housing 1 is connected to the brake pedal or the gas pedal. Then, the path of solenoid plunger 4 of solenoid plunger housing 1 represents a measure for the operation of the brake pedal or the gas pedal.

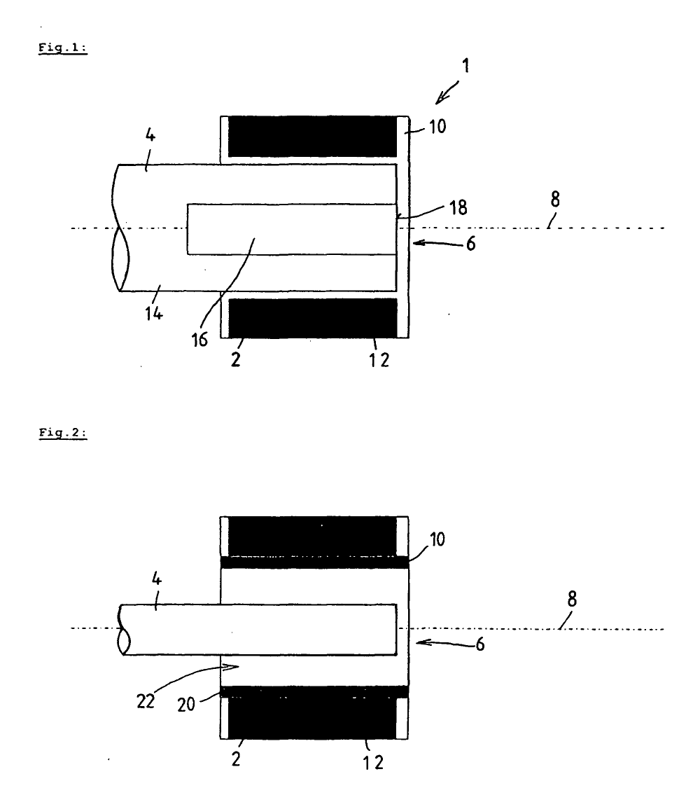

For the exemplary embodiment of the present invention, FIG. 1 shows a solenoid plunger housing 1 according to a first specific embodiment of the present invention. Solenoid plunger housing 1 is used to convert a mechanical linear motion to an electrical signal that is proportional to the linear motion, within the scope of a contactless inductive measuring method.

For this purpose, solenoid plunger housing 1 includes at least one coil 2 that is equipped with electrically conductive windings and may be hollow-cylindrical, as well as solenoid plunger 4, that plunges into a coil opening 6 of coil 2, and is movable in a linear manner together with the brake pedal or the gas pedal. As a function of its degree of plunging ratio or its overlapping ratio with reference to the magnetic field of coil 2, a different inductance L of coil 2 is then brought about.

The physical basis used for the measuring principle is described below. In general, a current I generates a magnetic field of field strength H in a cylindrical coil 2.

$$H = I \cdot \frac{n}{l} \qquad ( 1 )$$

where n is the number of turns and 1 is the coil length. Field strength H generates a magnetic flux density B

B=μᵣ·μ₀·H (2)

where μ₀ is the permeability and μᵣ is the relative permeability, the latter being given by

μᵣ<1 for diamagnetic materials,

μᵣ>1 for paramagnetic materials, and

μᵣ>>1 for ferromagnetic materials.

A change in the magnetic flux density B induces a voltage

U_{ind}=n·\dot{B}·A (3)

in coil 2. From equations (1) through (3), one then obtains for induced voltage U_{ind}:

$${U}_{ind} = n \cdot A \cdot {μ}_{r} \cdot {μ}_{0} \cdot \frac{n}{l} \cdot \dot{I} \qquad ( 4 )$$

For inductance L of coil 2

$$L = {n}^{2} \cdot {μ}_{r} \cdot {μ}_{0} \cdot \frac{A}{l} \qquad ( 5 )$$

is then obtained.

Coil 2 and solenoid plunger 4 are positioned coaxially with respect to a common coil axis 8. Coil 2, which is cylindrical, for example, may have its own coil shell 10, onto which is wound a coil winding 12 made of electrically conductive wire, made of copper wire, for example, as well as electric terminals. Solenoid plunger 4 is also cylindrical, and is especially developed in such a way that inductance L of coil 2 is linearly a function of the plunging depth of solenoid plunger 4 into cylindrical coil opening 6.

According to the specific embodiment of FIG. 1, solenoid plunger 4, in a radially outer section 14, is made at least partially of a nonferrous metal having a high electrical conductivity, and in a radially inner section 16 is made at least partially of a ferromagnetic material.

Among the nonferrous metals are aluminum, copper, gold, silver, etc., for example. They stand out, in general, by their high electrical conductivity. In particular, the electrical conductivity of the nonferrous metal of outer section 14 of solenoid plunger 4 is greater than that of the ferromagnetic material of radially inner section 16 of solenoid plunger 4.

A ferromagnetic material is generally understood to mean a magnetically conductive or soft magnetic material which has a relative permeability μ>>1 and a magnetic susceptibility χ>0. Among the ferromagnetic materials are iron, cobalt or nickel, for example. They considerably strengthen the magnetic field that penetrates them by lowering the magnetic resistance.

It particularly may be provided if the nonferrous metal in radially outer section 14 of solenoid plunger 4 is paramagnetic or diamagnetic, at a high electrical conductivity at the same time, in order to generate eddy currents that are as strong as possible, and with that, as large as possible a reverse magnetic field, which acts counter to the magnetic field of coil 2.

A paramagnetic material is understood to mean a material having a relative permeability of μ>1 and a magnetic susceptibility of χ>0. Such a paramagnetic material is platinum or aluminum, for instance.

A diamagnetic material is understood to mean a material having a relative permeability of μ<1 and a magnetic susceptibility of χ<0. Such a paramagnetic material is copper or silver, for instance.

The nonferrous metal may be formed by aluminum or by an aluminum alloy, or it contains these materials.

Radially inner section 16 of solenoid plunger 4, made completely of ferromagnetic material, for instance, which may form a one-piece core of solenoid plunger 4. This core 16 may be embedded at least partially in radially outer section 14 of solenoid plunger 4, which may be made up of the electrically conductive nonferrous metal. Furthermore, core 16 may extend only over a part of the length of solenoid plunger 4. This may, for instance, be implemented in that radially outer section 14 of solenoid plunger 4 has a central blind-end bore, into which core 16 is inserted or embedded. In this context, end face 18 of core 16 is exposed, for instance, and ends flush with an end face of solenoid plunger 4. Core 16 and radially outer section 14 of solenoid plunger 4 are longer than coil 2.

According to the specific embodiment of FIG. 2, in which the same component parts or component parts acting the same have the same reference numerals as in FIG. 1, a ring 20, that may be made completely of a nonferrous metal having a high electrical conductivity, forms at least one part of coil shell 10 of coil 2. This may be implemented in that coil shell 10 is an injection molded blank made of plastic into which ring 20 is cast, for example. According to an additional variant, ring 20, made of the electrically conductive nonferrous metal, is neither integrated into coil shell 10 of coil 2, nor is it connected directly to coil shell 10, but is situated only at its radially inner circumferential surface.

In an exemplary embodiment, solenoid plunger 4 is made completely of a ferromagnetic material. An improved magnetic shielding, of solenoid plunger 4 from the magnetic field of coil 2, comes about if ring 20 laterally projects beyond the coil winding by a portion. Ring gap 22 arranged between solenoid plunger 4 and ring 20, as seen in the radial direction, which may contain air. Solenoid plunger 4 is longer than ring 20 or coil 2.

Against this background, the method of functioning of solenoid plunger housing 1, according to the exemplary embodiments and/or exemplary methods of the present invention, is as follows:

Because of a linear motion of solenoid plunger 4 with respect to coil 2, that is to be sensed, there is a change in the depth of plunging into coil opening 6. This change in the plunging depth or the overlapping surface with coil opening 6 changes self-inductance L of the coil, which is used for obtaining a signal.

The excitation of coil 2 may take place, for instance, by a microprocessor, which feeds rectangular, sinusoidal or any desired pulses of an alternating voltage source into coil 2. Self-inductance L of coil 2 may be determined from the time of decay of the pulse to a lower boundary value. In this case, the linear motion of solenoid plunger 4 relative to coil 2 is determined using a time measurement.

Now, according to FIG. 1, if outer section 14 of solenoid plunger 4, that is made of the electrically conductive nonferrous metal, is inserted into the alternating magnetic field of coil 2, or according to FIG. 2, if a ring 20 made of the electrically conductive nonferrous metal is already located in the alternating magnetic field of coil 2, eddy currents are created in nonferrous metal 14, 20, which produce a magnetic field in the opposite direction to the magnetic field generated by coil 2, and thereby weaken the magnetic field of coil 2. However, according to FIG. 1, since core 16 of solenoid plunger 4, or according to FIG. 2, since entire solenoid plunger 4 is made of a ferromagnetic material, the reverse magnetic field generated by the eddy currents in outer section 14 of solenoid plunger 4 or in ring 20, is strengthened. The magnetic field of coil 2 is then greatly weakened by the reverse magnetic field that is then strengthened by radially inner ferromagnetic material 16, 4. This leads to solenoid plunger housing 1 reacting more sensitively with respect to relative motions between solenoid plunger 4 and coil 2, and consequently having a high resolution.

The list of reference numerals is as follows:
1 solenoid plunger housing;
2 coil;
4 solenoid plunger;
6 coil opening;
8 coil axis;
10 coil shell;
12 coil winding;
14 radially outer section;
16 radially inner section;
18 end face;
20 ring; and
22 ring gap.

1-14. (canceled)

15. A solenoid plunger housing, comprising:
at least one electric coil equipped with windings;
at least one solenoid plunger cooperating with the at least one electric coil, which, as a function of a plunging depth of the at least one solenoid plunger into a coil opening of the coil, brings about a different inductance of the coil;
wherein one of the following is satisfied: (a) the solenoid plunger, in a radially outer section, is made at least partially of an electrically conductive nonferrous metal, and in a radially inner section, is made at least partially of a ferromagnetic material; and (b) a ring is situated directly or indirectly at a radially inner circumferential surface of the coil that is made at least partially of an electrically conductive nonferrous metal, and the solenoid plunger is made at least partially of a ferromagnetic material.

16. The solenoid plunger housing of claim 15, wherein the nonferrous metal is paramagnetic or diamagnetic.

17. The solenoid plunger housing of claim 16, wherein the nonferrous metal is formed by aluminum or by an aluminum alloy.

18. The solenoid plunger housing of claim 15, wherein the radially inner section of the solenoid plunger, made at least partially of a ferromagnetic material, forms a one-piece core of solenoid plunger.

19. The solenoid plunger housing of claim 18, wherein the core is embedded at least partially in the radially outer section of the solenoid plunger, which is made up of the electrically conductive nonferrous metal.

20. The solenoid plunger housing of claim 19, wherein the core extends over only a part of the length of solenoid plunger.

21. The solenoid plunger housing of claim 20, wherein the radially outer section of the solenoid plunger has a central blind-end bore into which the core is inserted.

22. The solenoid plunger housing of claim 21, wherein the core terminates flush with an end face of the solenoid plunger.

23. The solenoid plunger housing of claim 22, wherein the core and radially outer section of the solenoid plunger are longer than the coil.

24. The solenoid plunger housing of claim 15, wherein the ring made of the electrically conductive nonferrous metal forms at least a part of a coil shell of the coil.

25. The solenoid plunger housing of claim 15, wherein the ring made of the electrically conductive nonferrous metal is situated at a radially inner circumferential surface of the coil shell of the coil.

26. The solenoid plunger housing of claim 24, wherein the solenoid plunger is completely made of the ferromagnetic material and has a greater length than the coil or the ring.

27. The solenoid plunger housing of claim 24, wherein the ring laterally projects beyond the coil winding by a portion.

28. The solenoid plunger housing of claim 24, wherein a ring gap arranged between the solenoid plunger and the ring, as seen in the radial direction, contains air.

29. The solenoid plunger housing of claim 15, wherein the solenoid plunger, in the radially outer section, is made at least partially of the electrically conductive nonferrous metal, and in the radially inner section, is made at least partially of the ferromagnetic material.

30. The solenoid plunger housing of claim 15, wherein the ring is situated directly or indirectly at the radially inner circumferential surface of the coil that is made at least partially of the electrically conductive nonferrous metal, and the solenoid plunger is made at least partially of the ferromagnetic material.
